(19) United States
(12) Patent Application Publication
(10) Pub. No.: US 2024/0145717 A1
(43) Pub. Date: May 2, 2024

(54) BINDER MATERIALS FOR MULTILAYERED ELECTRODES

(71) Applicant: EnPower, Inc., Indianapolis, IN (US)

(72) Inventors: Adrian YAO, Palo Alto, CA (US); Matthew DURANT, Scottsdale, AZ (US)

(21) Appl. No.: 18/051,325

(22) Filed: Oct. 31, 2022

(51) Int. Cl. H01M 4/62; H01M 4/04

(52) U.S. Cl. CPC H01M 4/622; H01M 4/0435

(57) ABSTRACT

Multilayered electrodes according to aspects of the present disclosure may include a bottom layer comprising a first plurality of electrode particles adhered together by a first binder, and a top layer comprising a second plurality of electrode particles adhered together by a second binder, wherein the first binder is configured to crosslink or coalesce upon calendering. In some examples, the first binder is configured to constrict expansion of electrode particles included in the bottom layer. In some examples, the bottom layer is configured to spring back by a lesser degree than the top layer upon calendering.

### FIELD

This disclosure relates to systems and methods for electrochemical cells. More specifically, the disclosed embodiments relate to binder materials for electrochemical cells.

### INTRODUCTION

Environmentally friendly sources of energy have become increasingly critical, as fossil fuel-dependence becomes less desirable. Most non-fossil fuel energy sources, such as solar power, wind, and the like, require some sort of energy storage component to maximize usefulness. Accordingly, battery technology has become an important aspect of the future of energy production and distribution. Most pertinent to the present disclosure, the demand for secondary (i.e., rechargeable) batteries has increased. Various combinations of electrode materials and electrolytes are used in these types of batteries, such as lead acid, nickel cadmium (NiCad), nickel metal hydride (NiMH), lithium ion (Li-ion), and lithium ion polymer (Li-ion polymer).

### SUMMARY

The present disclosure provides systems, apparatuses, and methods relating to binder materials for multilayered electrodes.

In some examples, a multilayered electrode according to the present disclosure includes: a current collector; a first layer comprising a first plurality of active material particles adhered together by a first binder; and a second layer comprising a second plurality of active material particles adhered together by a second binder; wherein the first binder is more crosslinked than the second binder.

In some examples, a multilayered electrode according to the present disclosure includes: a current collector; a first layer comprising a first plurality of active material particles adhered together by a first binder; and a second layer comprising a second plurality of active material particles adhered together by a second binder; wherein the first binder comprises binder materials configured to coalesce upon calendering; and wherein the second binder comprises binder materials not susceptible to coalescing upon calendering.

In some examples, a method of manufacturing a multilayered electrode according to the present disclosure includes: coating a first layer onto a current collector, the first layer comprising a first plurality of active material particles adhered together by a first binder, wherein the first binder comprises binder materials which are configured to coalesce upon calendering; coating a second layer onto the first layer, the second layer comprising a second plurality of active material particles adhered together by a second binder, wherein the second binder comprises binder materials which are not susceptible to coalescence upon calendering; and causing the first binder to coalesce and form a film surrounding the first plurality of active material particles by calendering the electrode.

Features, functions, and advantages may be achieved independently in various embodiments of the present disclosure, or may be combined in yet other embodiments, further details of which can be seen with reference to the following description and drawings.

### BRIEF DESCRIPTION OF THE DRAWINGS

FIG. 1 is a schematic sectional view of an illustrative electrochemical cell in accordance with aspects of the present disclosure.

FIG. 2 is a schematic sectional view of an illustrative multilayered electrode including tailored binder materials in an uncalendared state, suitable for inclusion in the illustrative electrochemical cell of FIG. 1.

FIG. 3 is a schematic sectional view of the multilayered electrode of FIG. 2 after heat treatment, calendering, or heated calendering.

FIG. 4 is a flow chart depicting steps of an illustrative method for manufacturing multilayered electrodes including tailored binder materials according to aspects of the present disclosure.

FIG. 5 is a schematic sectional view of an illustrative electrode undergoing a calendering process in accordance with aspects of the present disclosure.

FIG. 6 is a schematic diagram of an illustrative manufacturing system including a slot die head having two die slots, suitable for manufacturing electrodes and electrochemical cells of the present disclosure.

FIG. 7 is a schematic diagram of an illustrative manufacturing system including a slot die head having three die slots, suitable for manufacturing electrodes and electrochemical cells of the present disclosure.

### DETAILED DESCRIPTION

Various aspects and examples of binder materials for multilayered electrodes, as well as related methods, are described below and illustrated in the associated drawings. Unless otherwise specified, binder materials in accordance with the present teachings, and/or its various components, may contain at least one of the structures, components, functionalities, and/or variations described, illustrated, and/or incorporated herein. Furthermore, unless specifically excluded, the process steps, structures, components, functionalities, and/or variations described, illustrated, and/or incorporated herein in connection with the present teachings may be included in other similar devices and methods, including being interchangeable between disclosed embodiments. The following description of various examples is merely illustrative in nature and is in no way intended to limit the disclosure, its application, or uses. Additionally, the advantages provided by the examples and embodiments described below are illustrative in nature and not all examples and embodiments provide the same advantages or the same degree of advantages.

This Detailed Description includes the following sections, which follow immediately below: (1) Definitions; (2) Overview; (3) Examples, Components, and Alternatives; (4) Advantages, Features, and Benefits; and (5) Conclusion. The Examples, Components, and Alternatives section is further divided into subsections, each of which is labeled accordingly.

### Definitions

The following definitions apply herein, unless otherwise indicated.

“Comprising,” “including,” and “having” (and conjugations thereof) are used interchangeably to mean including but not necessarily limited to, and are open-ended terms not intended to exclude additional, unrecited elements or method steps.

Terms such as “first”, “second”, and “third” are used to distinguish or identify various members of a group, or the like, and are not intended to show serial or numerical limitation.

“AKA” means “also known as,” and may be used to indicate an alternative or corresponding term for a given element or elements.

“Elongate” or “elongated” refers to an object or aperture that has a length greater than its own width, although the width need not be uniform. For example, an elongate slot may be elliptical or stadium-shaped, and an elongate candlestick may have a height greater than its tapering diameter. As a negative example, a circular aperture would not be considered an elongate aperture.

“Coupled” means connected, either permanently or releasably, whether directly or indirectly through intervening components.

“Resilient” describes a material or structure configured to respond to normal operating loads (e.g., when compressed) by deforming elastically and returning to an original shape or position when unloaded.

“Rigid” describes a material or structure configured to be stiff, non-deformable, or substantially lacking in flexibility under normal operating conditions.

“Elastic” describes a material or structure configured to spontaneously resume its former shape after being stretched or expanded.

Directional terms such as “up,” “down,” “vertical,” “horizontal,” and the like should be understood in the context of the particular object in question. For example, an object may be oriented around defined X, Y, and Z axes. In those examples, the X-Y plane will define horizontal, with up being defined as the positive Z direction and down being defined as the negative Z direction.

“Providing,” in the context of a method, may include receiving, obtaining, purchasing, manufacturing, generating, processing, preprocessing, and/or the like, such that the object or material provided is in a state and configuration for other steps to be carried out.

“Coalescence” describes the disappearance of the boundary between two particles in contact, or between a particle and a bulk phase followed by changes of shape leading to a reduction of the total surface area of the particles. “Coalescence” of a binder material refers to the interdiffusion of polymer particles originating from a latex, colloidal dispersion, emulsion, or wax, such that the binder forms a homogeneous structure surrounding the electrode particles. Coalescence of a binder material begins during and/or after solvent (e.g., water) evaporation during a drying and/or heating manufacturing step.

“Crosslinking” refers to the linking of polymer chains by bonds or sequences of bonds called “crosslinks.” “Crosslinks” may be covalent structures, weaker chemical interactions, portions of crystallites, physical entanglements, and/or any suitable regions where two polymer chains are joined together. “Crosslinking” generally increases the rigidity, solvent resistance, and glass transition temperature (T g) of a polymeric material. A “crosslinked” binder material includes bonds or links throughout the material which form a matrix immobilizing the electrode particles. The crosslinked matrix limits electrode material mobility and provides resistance to electrode swelling.

“Springback” refers to the recovery of size and/or shape experienced by elastically deformed particles. Electrode particles, such as active material particles and/or binder particles “spring back” at different rates depending on the resiliency and/or rigidity of the electrode particles. When referring to an electrode layer, “springback” refers to a gradual thickness increase after calendering. Accordingly, an electrode layer including coalescing or crosslinked binder particles may “spring back” to a lesser extent than an electrode layer including discrete or uncrosslinked binder particles.

“Glass transition temperature (T g)” refers to the temperature at which polymer chain mobility occurs in a polymer. Accordingly, applying pressure to a polymer material at the glass transition temperature causes the polymer chains to slide past each other. Polymers with a flexible backbone have a lower glass transition temperature, and polymers with a lower molecular weight have a lower glass transition temperature.

In this disclosure, one or more publications, patents, and/or patent applications may be incorporated by reference. However, such material is only incorporated to the extent that no conflict exists between the incorporated material and the statements and drawings set forth herein. In the event of any such conflict, including any conflict in terminology, the present disclosure is controlling.

### Overview

In general, a multilayered electrode including binder materials in accordance with the present teachings includes a first electrode layer comprising a first plurality of electrode particles (e.g., active material particles) adhered together by a first binder and a second electrode layer comprising a second plurality of electrode particles (e.g., active material particles) adhered together by a second binder. Generally, the first binder comprises a coherent mass of binder material which constricts electrode springback after electrode compression (e.g., calendering), while the second binder comprises interwoven linear (i.e., unbranched) polymer chains which spring back after electrode compression. In a finished state, the first binder forms a homogeneous film or crosslinked matrix which immobilizes the first plurality of electrode particles, forming a rigid electrode layer. In contrast, the second binder comprises interwoven polymer chains intermixed with the second plurality of electrode particles, forming a resilient electrode layer. In some examples, the first binder comprises materials which coalesce upon application of heat and/or pressure (AKA particle coalescing binders). In some examples, the first binder comprises materials which form crosslinks upon application of heat and/or pressure (AKA cross-linking binders).

The configuration of binder materials described herein facilitates a desirable porosity profile after electrode compression. Electrode compression affects the porosity of an electrode, as active material particles, binder particles, and electrode additives deform under heat and/or pressure applied during electrode compression. Binder materials which coalesce and/or crosslink upon the application of heat and/or pressure form layers which have comparatively higher energy densities and comparatively lower porosities. In contrast, binder materials which are not susceptible to coalescence or crosslinking upon the application of heat and/or pressure form layers which have comparatively lower energy densities and comparatively higher porosities.

Binder coalescence and/or cross-linking may be promoted with any suitable method of applying heat and/or pressure to the electrode, such as heat treatment (e.g., in an oven), pressure upon electrode compression (e.g., calendering), heated calendering, and/or the like. In some examples, the electrode is exposed to heat (e.g., in an oven) before the electrode is compressed and/or calendered. In some examples, the electrode is calendered using one or more heated rollers, which both heat and compress the electrode. Binder coalescence occurs as latex particles merge, accordingly, heat and/or pressure treatment may soften the particles and cause the first binder to coalesce.

Electrode manufacturing involves tradeoffs between capacity and power. Electrodes having high energy densities and high capacities (AKA energy cells) often experience low charge and discharge rates. In contrast, electrodes having fast charge and discharge rates (AKA power cells) often have lower capacities and energy densities. Accordingly, an electrode including a first (AKA bottom) layer having a comparatively high energy density and a comparatively low porosity and a second (AKA top) layer having a comparatively high porosity and a comparatively low energy density has advantages over electrodes with a single layer, combining the benefits of an energy cell and a power cell.

Furthermore, an electrode including a top layer having a higher porosity than the bottom layer may have a desirable lithiation profile. Generally, the closer an active material particle is to the current collector, the longer a path length a lithium ion must travel to react with the active material particle. Accordingly, in conventional electrodes, a lithium ion is more likely to react with active material particles which are in the top layer of the electrode than in the bottom layer of the electrode. However, in multilayered electrodes according to the present teachings, the higher porosity of the top layer facilitates a lower residence time of lithium ions in the top layer than in the bottom layer. The greater residence time of lithium ions in the bottom layer increases the likelihood that lithium ions will react with active material particles in the bottom layer. The following negative effects are avoided: (1) a polarization overpotential in the electrolyte leading to parasitic energy losses within the electrochemical cell, and (2) underutilization of the bottom layer compared to the top layer (causing, e.g., lower apparent lithium-ion battery capacity and/or longer time to complete acceptance of lithium by the electrode at lower power).

In some examples, the first binder comprises binder materials which coalesce upon the application of heat and/or pressure. Accordingly, in some examples, the first binder comprises colloidal dispersions (AKA latexes) and/or emulsions, such as styrene-butadiene rubber (SBR), poly(vinylidene fluoride) (PVDF), poly(vinylidene fluoride-co-hexafluoropropylene) (PVDF-HFP), wax emulsions, and/or the like. In some examples, the first binder comprises micron and/or nano-sized wax and/or polymer particles, such as polyethylene, fisher-tropsch waxes, soy (or other bio-based) waxes, polyethylene oxide wax, and/or the like. In some examples, such as when the multilayered electrode is a cathode or when the electrode is a non-aqueous system (e.g., includes non-aqueous solvents, etc.), the first binder comprises a dispersion of water-soluble wax particles such as polyethylene glycol and/or the like.

In some examples, the first binder comprises binder materials which form crosslinks upon the application of heat and/or pressure. Accordingly, in some examples, the first binder comprises any suitable material or mixture of materials which forms a crosslinked matrix upon calendering, such as poly(vinyl alcohol)/poly(acrylic acid) (PVA-PAA) (esterification crosslinking), carboxymethyl cellulose/poly(acrylic acid) (CMC-PAA) (esterification crosslinking), carboxymethyl cellulose/polyethylene glycol (CMC-PEG) (epoxide crosslinking), poly(vinyl pyrollidine) crosslinking, and/or the like. In some examples, the first binder comprises a polymer mixed with a crosslinking agent.

Accordingly, the first binder forms a coherent structure upon calendering, which immobilizes the first electrode particles in a matrix formed by the first binder materials. In some examples, particles of the first binder are configured to merge and become indistinguishable from each other upon calendering. In some examples, particles of the first binder are configured to form a crosslinked matrix (e.g., network) upon calendering. The first binder may be described as experiencing plastic deformation, as the first binder particles are irreversibly modified by the application of heat and/or compressive force. The first layer does not return to its original thickness or density after the compressive force is removed.

In contrast, the second binder comprises binder materials which are not susceptible to coalescence or crosslinking upon calendering. Accordingly, after the electrode has been calendered and any solvents have been evaporated, the second layer comprises a plurality of interwoven linear polymer chains mixed with a plurality of second electrode particles. The interwoven linear polymer chains precipitate out of the second binder solution upon solvent evaporation, resulting in an interwoven structure comprising discrete polymer chains. The interwoven linear polymer chains do not react to form a cross-linked structure, and do not coalesce upon solvent evaporation. Accordingly, the interwoven linear polymer chains may be dissolvable. The second layer is more porous than the first layer, due to the presence of interstices between the second electrode particles and the plurality of interwoven linear polymer chains. Due to the porosity of the second layer and the resiliency of the second binder, the second electrode layer may experience elastic deformation upon calendering. After the compressive force applied by the calendering rollers is removed, the second electrode layer may spring back to a thickness between its uncompressed thickness and its compressed thickness. The second binder may comprise any suitable material which does not coalesce upon calendering, such as sodium carboxymethyl cellulose (NaCMC), poly(vinyl alcohol) (PVA), poly(acrylic acid) (PAA), sodium poly(acrylic acid) (NaPAA), sodium alginate, chitosan, guar gum, xanthan gum, polyethylene glycol, and/or the like. In some examples, the first binder materials are emulsions and the second binder materials are solutions. Accordingly, upon heating and/or calendering, the first binder materials may coalesce while the second binder materials may precipitate out of the solution, forming discrete polymer chains.

In some examples, the multilayered electrode comprises two active material layers. Accordingly, the first plurality of electrode particles may comprise a first plurality of active material particles and the second plurality of electrode particles may comprise a second plurality of active material particles. In some examples, the multilayered electrode comprises an active material layer and an integrated separator layer. Accordingly, the first plurality of electrode particles may comprise a first plurality of active material particles and the second plurality of electrode particles may comprise a first plurality of ceramic separator particles.

In some examples, the multilayered electrode is an anode. Accordingly, the first binder material may constrict expansion of silicon and/or silicon oxide particles included in the bottom layer of the anode. As silicon and silicon oxide particles are prone to swelling during electrode charging and discharging, encapsulating the silicon and/or silicon oxide particles in a matrix formed by the first binder may improve electrode coherence and stability. In some examples, the first plurality of electrode particles comprise silicon, silicon oxide, or a mixture of silicon and silicon oxide, and the second plurality of electrode particles comprise graphite.

A method of manufacturing a multilayered electrode according to aspects of the present disclosure may include: applying a first electrode slurry to a current collector substrate, wherein the first electrode slurry comprises a plurality of first electrode particles intermixed with a first binder; applying a second electrode slurry to the first electrode slurry, wherein the second electrode slurry comprises a plurality of second electrode particles intermixed with a second binder; and calendering the multilayered electrode, such that the first binder immobilizes the first electrode particles within a matrix formed by the first binder. In some examples, the second binder may comprise materials which are not susceptible to coalescence upon calendering. In some examples, the method further comprises heating the electrode.

### Examples, Components, and Alternatives

The following sections describe selected aspects of illustrative binders for multilayered electrodes as well as related systems and/or methods. The examples in these sections are intended for illustration and should not be interpreted as limiting the scope of the present disclosure. Each section may include one or more distinct embodiments or examples, and/or contextual or related information, function, and/or structure.

### A. Illustrative Electrochemical Cell

This section describes an electrochemical cell including an electrode according to the present teachings. The electrochemical cell may be any bipolar electrochemical device, such as a battery (e.g., lithium-ion battery, secondary battery, etc.).

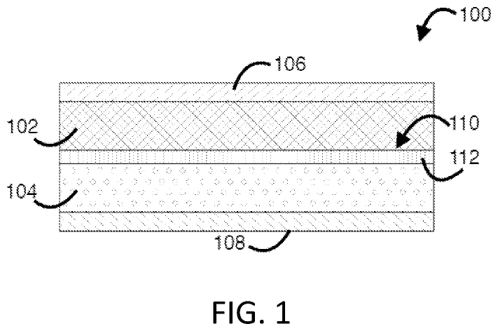

Referring now to FIG. 1, an electrochemical cell 100 is illustrated schematically in the form of a lithium-ion battery. Electrochemical cell 100 includes a positive and a negative electrode, namely a cathode 102 and an anode 104. The cathode and the anode are sandwiched between a pair of current collectors 106, 108, which may comprise metal foils or other suitable substrates. Current collector 106 is electrically coupled to cathode 102, and current collector 108 is electrically coupled to anode 104. In some examples, current collector 106 comprises aluminum foil and current collector 108 comprises copper foil. Current collectors 106 and 108 enable the flow of electrons, and therefore electrical current, into and out of each electrode. An electrolyte 110 disposed throughout the electrodes enables the transport of ions between cathode 102 and anode 104. Electrolyte 110 facilitates an ionic connection between cathode 102 and anode 104. In some examples, electrolyte 110 includes a liquid solvent and a solute of dissolved ions. In some examples, electrolyte 110 includes a gel solvent and a solute of dissolved ions. In some examples, electrolyte 110 includes a solid ion conductor intermixed with active material particles of cathode 102 and anode 104.

Electrolyte 110 is assisted by a separator 112, which physically partitions the space between cathode 102 and anode 104. Separator 112 electrically isolates cathode 102 and anode 104 from each other, preventing shorting within the electrochemical cell. Separator 112 is permeable to electrolyte 110, and enables the movement (AKA flow) of ions within electrolyte 10 and between the two electrodes. In some examples, separator 112 may be integrated within one or both of cathode 102 and anode 104. In some examples, separator 112 comprises a layer of ceramic particles applied to a top surface of an electrode (i.e., cathode 102 or anode 104), such that the ceramic particles of separator 112 are interpenetrated or intermixed with active material particles of cathode 102 or anode 104. As separator 112 insulates the electrodes from each other, ceramic particles included in separator 112 may be electrically non-conductive and electrochemically inactive. In some examples, separator 112 comprises a layer of a polymer gel (e.g., polyolefin) disposed between cathode 102 and anode 104. In some examples, electrolyte 110 includes a polymer gel or solid ion conductor, augmenting or replacing (and performing the function of separator 112).

Cathode 102 and anode 104 are composite structures, which comprise active material particles, binders, conductive additives (AKA conductive aids), and pores (i.e., void space) into which electrolyte 110 may penetrate. An arrangement of the constituent parts of an electrode is referred to as a microstructure, or more specifically, an electrode microstructure.

Binders adhere the constituent parts of the electrode together, forming the electrode microstructure. Different binder materials may produce electrode layers with different degrees of springback upon calendering. For example, binders may comprise colloidal dispersions (AKA latexes) and/or emulsions, such as styrene-butadiene rubber (SBR), poly(vinylidene fluoride) (PVDF), poly(vinylidene fluoride-co-hexafluoropropylene) (PVDF-HFP), wax emulsions, and/or the like or micron and/or nano-sized wax and/or polymer particles, such as polyethylene, fisher-tropsch waxes, soy (or other bio-based) waxes, polyethylene oxide wax, and/or the like, which may coalesce upon calendering, forming a homogeneous structure comprising interdiffused polymer chains. In some examples, the binder comprises any suitable material or mixture of materials which forms a crosslinked matrix upon calendering, such as poly(vinyl alcohol)/poly(acrylic acid) (PVA-PAA) (esterification crosslinking), carboxymethyl cellulose/poly(acrylic acid) (CMC-PAA) (esterification crosslinking), carboxymethyl cellulose/polyethylene glycol (CMC-PEG) (epoxide crosslinking), poly(vinyl pyrollidine) crosslinking, and/or the like. In some examples, the binder comprises any suitable material which does not coalesce upon calendering, such as sodium carboxymethyl cellulose (NaCMC), poly(vinyl alcohol) (PVA), poly(acrylic acid) (PAA), sodium poly(acrylic acid) (NaPAA), sodium alginate, chitosan, guar gum, xanthan gum, polyethylene glycol, and/or the like.

Coalescing and crosslinking binders have a lower degree of springback than binders which do not coalesce upon calendering, resulting in electrode layers with higher energy densities and overall densities, but lower porosities. Accordingly, binder selection may affect a porosity profile of the electrode.

In some examples, the conductive additive includes a carbon black, a ketjen black, a graphitic carbon, a low dimensional carbon (e.g., carbon nanotubes), micron-sized carbon (e.g., flake graphite), and/or a carbon fiber.

Electrochemical cell 100 may include packaging (not shown). For example, packaging (e.g., a prismatic can, stainless steel tube, polymer and/or mylar pouch, etc.) may be utilized to constrain and position cathode 102, anode 104, current collectors 106 and 108, electrolyte 110, and separator 112.

In some examples, the chemistry of the active material particles differs between cathode 102 and anode 104. For example, anode 104 may include active material particles comprising graphite (artificial or natural), hard carbon, lithium metal, silicon, silicon oxide, titanate, titania, transition metals in general, elements in group 14 (e.g., carbon, silicon, tin germanium, etc.), oxides, sulfides, halides, and/or chalcogenides. On the other hand, cathode 102 may include active material particles comprising transition metals (for example, nickel, cobalt, manganese, copper, zinc, vanadium, chromium, iron), and their oxides, phosphates, phosphites, silicates, alkalines and alkaline earth metals, aluminum, aluminum oxides and aluminum phosphates, halides and/or chalcogenides.

In an electrochemical device such as electrochemical cell 100, active materials participate in an electrochemical reaction or process with a working ion to store or release energy. For example, in a lithium-ion battery, the working ions are lithium ions. For electrochemical cell 100 to properly function as a secondary battery, active material particles in both cathode 102 and anode 104 must be capable of storing and releasing ions through the respective processes known as lithiating and delithiating. Some active materials (e.g., layered oxide materials, graphitic carbon, etc.) fulfill this function by intercalating lithium ions between crystal layers or within interstitial spaces within a crystal lattice. Other active materials may have alternative lithiating and delithiating mechanisms (e.g., alloying, conversion, etc.).

When electrochemical cell 100 is being charged, anode 104 accepts lithium ions while cathode 102 donates lithium ions. In other words, lithium ions stored by the cathode travel to and are stored by the anode, lithiating the anode and delithiating the cathode. When a cell is being discharged, anode 104 donates lithium ions while cathode 102 accepts lithium ions. In other words, lithium ions stored by the anode travel to and are stored by the cathode, lithiating the cathode and delithiating the anode. Each composite electrode (i.e., cathode 102 and anode 104) has a rate at which it donates or accepts lithium ions that depends on properties extrinsic to the electrode (e.g., the current passed through each electrode, the conductivity of electrolyte 110) as well as properties intrinsic to the electrode (e.g., a solid state diffusion constant of the electrode and of active material particles in the electrode; the electrode microstructure or tortuosity; the charge transfer rate at which lithium ions move from being solvated in the electrolyte to being intercalated in the active material particles of the electrode; etc.).

During either mode of operation (charging or discharging), anode 104 or cathode 102 may donate or accept lithium ions at a limiting rate, where rate is defined as lithium ions per unit time, per unit current. For example, during charging, anode 104 may accept lithium at a first rate, and cathode 102 may donate lithium at a second rate. When the second rate is less than the first rate, the second rate of the cathode would be a limiting rate. In some examples, the differences in rates may be so dramatic as to limit the overall performance of the lithium-ion battery (e.g., cell 100). Reasons for the differences in rates may depend on an energy required to lithiate or delithiate a quantity of lithium-ions per mass of active material particles; a solid-state diffusion coefficient of lithium ions in an active material particle; and/or a particle size distribution of active material within a composite electrode. In some examples, charge and discharge rates are influenced by an impedance of the separator, which may depend on a total thickness of the separator, a particle size distribution of the separator particles, a porosity of the separator microstructure, a porosity of ceramic particles included within the separator, and/or a total density of the separator. In some examples, additional or alternative factors may contribute to the electrode microstructure and affect these rates.

### B. Illustrative Multilayered Electrode

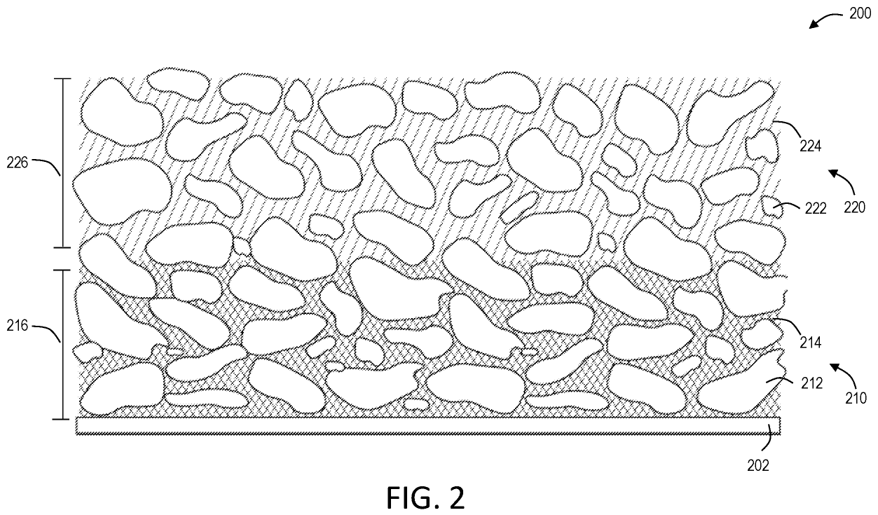

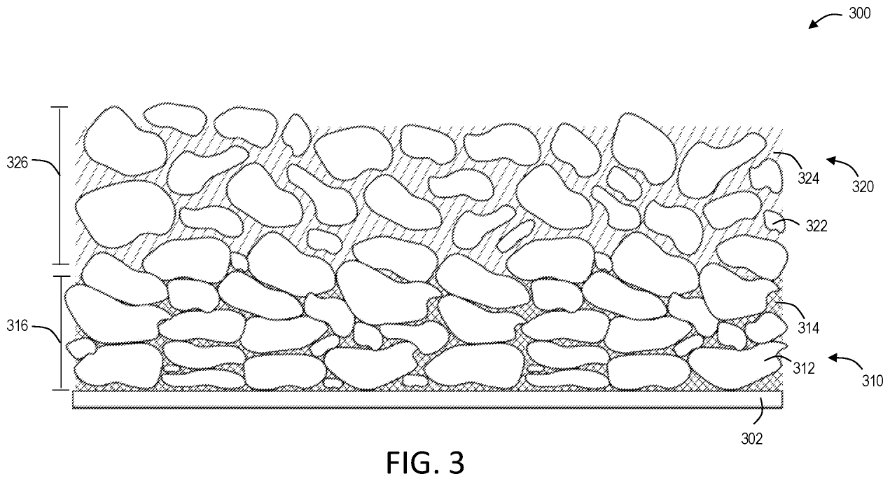

As shown in FIGS. 2-3, this section describes an illustrative multilayered electrode 200 including tailored binder materials. FIG. 2 depicts multilayered electrode 200 before the electrode has been calendered. FIG. 3 depicts multilayered electrode 300 in a finished (e.g., post-calendering) state. Electrode 200 is an example of an anode or cathode suitable for inclusion in an electrochemical cell, similar to cathode 102 or anode 204, described above. Multilayered electrode 200 includes a first (AKA bottom) electrode layer 210 comprising a first plurality of active material particles 212 mixed with a first binder 214 and a second (AKA top) electrode layer 220 comprising a second plurality of active material particles 222 mixed with a second binder 224. In some examples, the first electrode layer is disposed on and directly contacting a current collector substrate 202. In some examples, electrode 200 includes an intermediate (AKA supplemental layer) disposed between the first electrode layer and current collector substrate 202. First binder 214 is configured to form a coherent matrix which constricts expansion of first layer 210 upon calendering. Accordingly, in some examples, first binder 214 comprises binder materials which coalesce upon exposure to heat and/or pressure. In some examples, first binder 214 comprises binder materials which form crosslinks upon exposure to heat and/or pressure. In contrast, second binder 224 comprises binder materials which spring back after calendering, and which are resistant to coalescence and/or crosslinking.

First layer 210 comprises a first plurality of active material particles 212 mixed with first binder 214. In some examples, first layer 210 is layered onto and directly contacting current collector 202. Active material particles 212 are electrochemically active, and therefore may swell and/or shrink during lithiation and/or delithiation of electrode 200. In some examples, first binder 214 is configured to repress expansion of active material particles 212. First binder 214 comprises materials which are configured to experience irreversible changes in shape and/or size upon application of heat and/or pressure, such as in a calendering process. In some examples, first binder 214 comprises materials which coalesce upon application of heat and/or pressure. In some examples, first binder 214 comprises colloidal dispersions (AKA latexes) and/or emulsions, such as styrene-butadiene rubber (SBR), poly(vinylidene fluoride) (PVDF), poly(vinylidene fluoride-co-hexafluoropropylene) (PVDF-HFP), wax emulsions, and/or the like. In some examples, the first binder comprises micron and/or nano-sized wax and/or polymer particles, such as polyethylene, fisher-tropsch waxes, soy (or other bio-based) waxes, polyethylene oxide wax, and/or the like. In some examples, the multilayered electrode is a cathode, and the first binder comprises a dispersion of water-soluble wax particles such as polyethylene glycol and/or the like. In some examples, first binder 214 comprises materials which form crosslinks upon application of heat and/or pressure. Accordingly, in some examples, the first binder comprises any suitable material or mixture of materials which forms a crosslinked matrix upon calendering, such as poly(vinyl alcohol)/poly(acrylic acid) (PVA-PAA) (esterification crosslinking), carboxymethyl cellulose/poly(acrylic acid) (CMC-PAA) (esterification crosslinking), carboxymethyl cellulose/polyethylene glycol (CMC-PEG) (epoxide crosslinking), poly(vinyl pyrollidine) crosslinking, and/or the like. In some examples, the first binder comprises a polymer mixed with a crosslinking agent.

Second layer 220 comprises a second plurality of active material particles 222 mixed with second binder 224. In some examples, second layer 220 is layered onto and directly contacting first layer 210. Second binder 224 comprises materials which are not susceptible to coalescence, resulting in higher degrees of electrode springback in the second layer after calendering. In some examples, the second binder comprises interwoven linear polymer chains. Second binder 224 comprises any suitable binder materials which are not susceptible to coalescence, such as such as sodium carboxymethyl cellulose (NaCMC), poly(vinyl alcohol) (PVA), poly(acrylic acid) (PAA), sodium poly(acrylic acid) (NaPAA), sodium alginate, chitosan, guar gum, xanthan gum, polyethylene glycol, and/or the like. In some examples, the second binder comprises a solution of binder particles in a solvent. In some examples, the second binder is dissolvable.

In some examples, the first binder comprises a first polymer mixed with a crosslinking agent, and the second binder consists essentially of the first polymer (e.g., the first binder comprises PVA-PAA and the second binder comprises PVA or PAA, etc.). In some examples, the first binder comprises a first polymer comprises a first polymer mixed with a crosslinking agent, and the second binder comprises a sodium salt of the first polymer (e.g., the first binder comprises CMC-PAA and the second binder comprises NaCMC or NaPAA, etc.).

In some examples, electrode 200 is an anode suitable for inclusion in an electrochemical cell (e.g., electrochemical cell 100). In the case of such an anode, active material particles 212, 222, may comprise graphite (artificial or natural), hard carbon, lithium metal, silicon, silicon oxide, titanate, titania, transition metals in general, elements in group 14 (e.g., carbon, silicon, tin, germanium, etc.), oxides, sulfides, transition metals, halides, 5 chalcogenides, and/or the like. In some examples, first active material particles 212 comprise silicon, silicon oxide, and/or a mixture thereof and second active material particles 222 comprise graphitic carbon. Accordingly, first binder 214 may constrict expansion of active material particles 212. As silicon and silicon oxide particles are prone to swelling during electrode charging and discharging, encapsulating the silicon and/or silicon oxide particles in a matrix formed by the first binder may improve electrode coherence and stability.

In some examples, electrode 200 is a cathode suitable for inclusion in an electrochemical cell (e.g., electrochemical cell 100). In the case of such a cathode, active material particles 212, 222 may comprise transition metals (e.g., nickel, cobalt, manganese, copper, zinc, vanadium, chromium, iron, etc.), and their oxides, phosphates, phosphites, and/or silicates. In some examples, active material particles 212, 222 may comprise alkalines and alkaline earth metals, aluminum, aluminum oxides and aluminum phosphates, as well as halides and chalcogenides.

In some examples, first layer 210 and/or second layer 220 comprise conductive additives, such as nanometer-sized carbons (e.g., carbon black), low dimensional carbons (e.g., carbon nanotubes), micron-sized carbons (e.g., flake graphite), ketjen black, graphitic carbon, carbon fiber, and/or the like.

The configuration of binder materials in electrode 200 facilitates a desirable porosity profile after electrode compression. Electrode 200 experiences changes in density and porosity as a result of heat and/or pressure applied to the electrode (e.g, during the calendering process). Applying heat and/or pressure to the electrode causes active material particles, binder particles, and electrode additives included in first layer 210 and second layer 220 to deform, either reversibly (i.e., elastic deformation) or irreversibly (i.e., plastic deformation). First binder materials 214 are configured to crosslink and/or coalesce upon application of heat and/or pressure, densifying the first electrode layer. Formation of crosslinks or coalescence of binder materials irreversibly changes the microstructure of the first electrode layer, resulting in comparatively low levels of electrode springback. In contrast, second binder materials 224 are configured to deform at lower rates than first binder materials 214, resulting in a resilient second layer which springs back at a greater rate than first layer 210.

Changes in porosity, density, and layer thickness experienced by first layer 210 and second layer 220 result in a desirable porosity profile after electrode compression and springback. As first layer 210 springs back at a lower rate, first layer 210 has a higher density, a lower porosity, and a higher energy density. In contrast, second layer 220 has a lower density, a lower porosity, and a lower energy density.

FIG. 2 depicts electrode 200 before electrode compression (e.g., calendering). As depicted in FIG. 2, layer 210 and layer 220 have generally similar thicknesses before the electrode is calendered. First layer 210 has a first pre-calendering thickness 216 and second layer 220 has a second pre-calendering thickness 226. However, layers 210 and 220 may have any suitable thicknesses. In some examples, layer 210 is thicker than layer 220. In some examples, layer 220 is thicker than layer 210. Similarly, layers 210 and 220 have generally similar amounts of space between active material particles. In some examples, active material particles in layer 210 are more closely packed than active material particles in layer 220. In some examples, active material particles in layer 220 are more closely packed than active material particles in layer 210.

Binder coalescence and/or cross-linking may be promoted with any suitable method of applying heat and/or pressure to the electrode, such as heat treatment (e.g., in an oven), pressure upon electrode compression (e.g., calendering), heated calendering, and/or the like. In some examples, the electrode is exposed to heat (e.g., in an oven) before the electrode is compressed and/or calendered. In some examples, the electrode is calendered using one or more heated rollers, which both heat and compress the electrode.

FIG. 3 depicts electrode 300 in a post-compressed state (i.e., post-calendering state). Electrode 300 is substantially identical to electrode 200, except as otherwise described. As in electrode 200, multilayered electrode 300 includes a first (AKA bottom) electrode layer 310 comprising a first plurality of active material particles 312 mixed with a first binder 314 and a second (AKA top) electrode layer 320 comprising a second plurality of active material particles 322 mixed with a second binder 324. In some examples, the first electrode layer is disposed on and directly contacting a current collector substrate 302. First binder 314 comprises a coherent matrix (e.g., crosslinked network, coalesced film, etc.) of binder material, surrounding and immobilizing first active material particles 312. In contrast, second binder 324 comprises interwoven linear polymer chains, which are not susceptible to crosslinking or coalescence. Accordingly, second layer 320 is susceptible to spring back after calendering.

First binder 314 forms a coherent structure upon calendering, which immobilizes the first electrode particles in a matrix formed by the first binder materials. In some examples, particles of the first binder are configured to merge and become indistinguishable from each other upon calendering. In some examples, particles of the first binder are configured to form a crosslinked matrix (e.g., network) upon calendering. The first binder may be described as experiencing plastic deformation, as the first binder particles are irreversibly modified by the application of heat and/or compressive force. The first layer does not return to its original thickness or density after the compressive force is removed.

In some examples, second layer 320 is more porous than first layer 310, which may be due to the presence of interstices between second active material particles 322 and polymer chains of second binder 324. Due to the porosity of the second layer and the resiliency of second binder 324, the second electrode layer may experience elastic deformation upon calendering. After the compressive force applied by the calendering rollers is removed, the second electrode layer may spring back to a thickness between its uncompressed thickness and its compressed thickness.

First electrode layer 310 has a first post-calendering thickness 316. Similarly, second electrode layer 320 has a second post-calendering thickness 326. Generally, a “post-calendering thickness” (i.e., post-springback thickness), as described herein refers to a thickness of an electrode layer some time after calendering. As electrode layers springback after calendering, a “post-calendering thickness” refers to a thickness of the electrode layers both after calendering and after layer springback. In other words, while the first electrode layer and the second electrode layer may be compressed by a similar degree during and immediately after calendering, the first layer may maintain its compressed thickness better than the second layer. Generally, both the first layer and the second layer decrease in thickness by 30-40% during calendering.

As the application of heat and/or pressure to the electrode layer causes first binder 314 to coalesce and/or crosslink, a ratio between first pre-calendering thickness 216 and first post-calendering thickness 316 is greater than a ratio between second pre-calendering thickness 226 and second post-calendering thickness 326. Similarly, a percent decrease in thickness between first pre-calendering thickness 216 and first post-calendering thickness 316 is greater than a percent decrease in thickness between second pre-calendering thickness 226 and second post-calendering thickness 326. In other words, first layer 310 is reduced in thickness by a greater degree than second layer 320 after the electrode layers have experienced springback. In some examples, the second electrode layer may spring back by 15-20% and the first electrode layer may spring back by 0-5% of the uncompressed electrode thickness.

In the example depicted in FIG. 3, layer 310 is thicker than layer 320. Post-calendering thickness 316 of layer 310 is less than post-calendering thickness 326 of layer 320. However, in some examples an initial thickness of layer 310 (thickness 216 of electrode 200) is greater than an initial thickness of layer 320 (thickness 226 of electrode 200). Accordingly, in some examples, thickness 316 of layer 310 may be greater than thickness 326 of layer 320. Similarly, in some examples, first layer 310 is less porous than first layer 210. In some examples, first layer 310 is less porous than second layer 320.

In some examples, calendering the electrode may cause first layer 310 and second layer 320 to have tailored physical properties. In some examples, calendering the electrode may cause first binder 314 to be resistant to solvents (AKA not dissolvable). In contrast, second binder 324 may be selected to be dissolvable. Accordingly, the second binder may be dissolvable, and the first binder may not be dissolvable. In some examples, calendering the electrode may cause the first binder to have a glass transition temperature (T g) that is higher than the glass transition temperature of the second binder, as crosslinked binders have a higher glass transition temperature than linear binders due to an increase in molecular weight. In some examples, prior to calendering, the first binder (e.g., binder 214) has a glass transition temperature that is lower than the second binder (e.g., binder 224). Accordingly, calendering the electrode causes the T g of the first binder to increase such that it is greater than the T g of the second binder. In some examples, calendering the electrode may cause first binder 314 to be resistant to melting.

### C. Illustrative Electrode Manufacturing Method

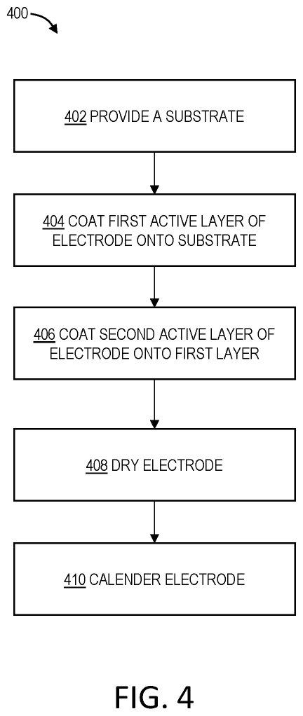

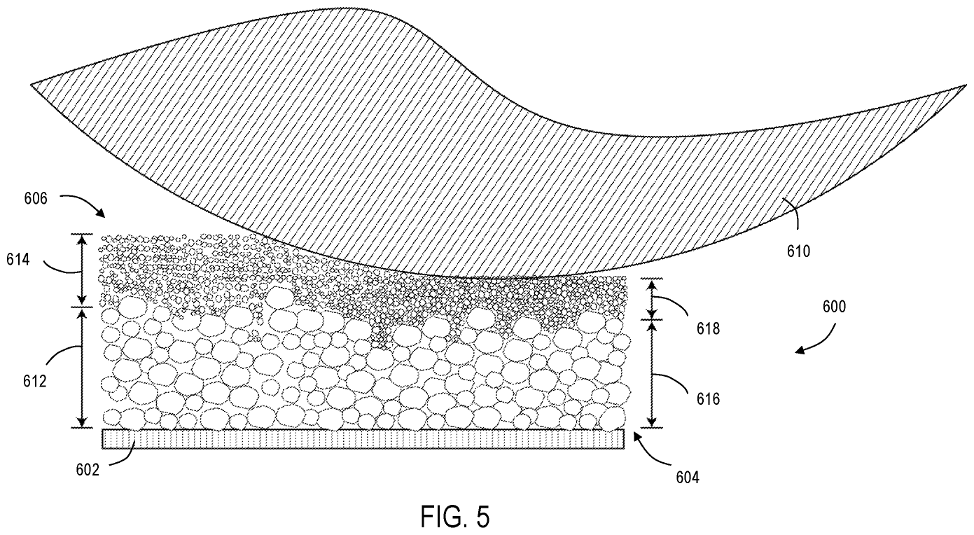

This section describes steps of an illustrative method 400 for manufacturing a multilayered electrode including tailored binder materials, see FIGS. 4 and 5. Aspects of electrode 200 may be utilized in the method steps described below. Where appropriate, reference may be made to components and systems that may be used in carrying out each step. These references are for illustration, and are not intended to limit the possible ways of carrying out any particular step of the method.

FIG. 4 is a flowchart illustrating steps performed in an illustrative method, and may not recite the complete process or all steps of the method. Although various steps of method 400 are described below and depicted in FIG. 4, the steps need not necessarily all be performed, and in some cases may be performed simultaneously, or in a different order than the order shown.

Step 402 of method 400 includes providing a substrate, wherein the substrate includes any suitable structure and material configured to function as a conductor in a secondary battery of the type described herein. In some examples, the substrate comprises a current collector. In some examples, the substrate comprises a metal foil. The term “providing” here may include receiving, obtaining, purchasing, manufacturing, generating, processing, preprocessing, and/or the like, such that the substrate is in a state and configuration for the following steps to be carried out. In some examples, providing a substrate includes loading the substrate onto a backing roll.

Method 400 next includes a plurality of steps in which at least a portion of the substrate is coated with an electrode material composite. This may be done by causing a current collector substrate and an electrode material composite dispenser to move relative to each other, by causing the substrate to move past an electrode material composite dispenser (or vice versa) that coats the substrate as described below. The composition of material particles in each electrode material composite layer may be selected to achieve the benefits, characteristics, and results described herein. The electrode material composite may include on or more electrode layers, each including a plurality of active material particles, and one or more separator layers, each including a plurality of inorganic material particles.

Step 404 of method 400 includes coating a first layer of a composite electrode on a first side of the substrate. In some examples, the first layer includes a plurality of first particles adhered together by a first binder, the first particles having a first average particle size (or other first particle distribution). In this example, the plurality of first particles may comprise a plurality of first active material particles, and the first layer may be described as an active material layer. As the first active material particles are electrochemically active, the first active material particles may swell and/or shrink during lithiation and/or delithiation of the multilayered electrode. Accordingly, the first binder may be configured to suppress expansion of the first active material particles. The first binder comprises materials which are configured to irreversibly change in shape and/or size upon application of heat (e.g., in step 408 of method 400) and/or pressure (e.g., in step 410 of method 400). In some examples, the first binder comprises materials which coalesce upon application of heat and/or pressure. In some examples, the first binder comprises colloidal dispersions (AKA latexes) and/or emulsions, such as styrene-butadiene rubber (SBR), poly(vinylidene fluoride) (PVDF), poly(vinylidene fluoride-co-hexafluoropropylene) (PVDF-HFP), wax emulsions, and/or the like. In some examples, the first binder comprises micron and/or nano-sized wax and/or polymer particles, such as polyethylene, fisher-tropsch waxes, soy (or other bio-based) waxes, polyethylene oxide wax, and/or the like. In some examples, the multilayered electrode is a cathode, and the first binder comprises a dispersion of water-soluble wax particles such as polyethylene glycol and/or the like. In some examples, the first binder comprises materials which form crosslinks upon application of heat and/or pressure. Accordingly, in some examples, the first binder comprises any suitable material or mixture of materials which forms a crosslinked matrix upon calendering, such as poly(vinyl alcohol)/poly(acrylic acid) (PVA-PAA) (esterification crosslinking), carboxymethyl cellulose/poly(acrylic acid) (CMC-PAA) (esterification crosslinking), carboxymethyl cellulose/polyethylene glycol (CMC-PEG) (epoxide crosslinking), poly(vinyl pyrollidine) crosslinking, and/or the like.

In some examples, the first active material layer includes conductive additives intermixed with the first particles and the first binder. In some examples, the conductive additives comprise nanometer-sized carbons (e.g., carbon black), low dimensional carbons (e.g., carbon nanotubes), micron-sized carbons (e.g., flake graphite), ketjen black, graphitic carbon, carbon fiber, and/or the like.

In some examples, the multilayered electrode is an anode suitable for inclusion within an electrochemical cell. In this case, the first active material particles may comprise graphite (artificial or natural), hard carbon, lithium metal, silicon, silicon oxide, titanate, titania, transition metals in general, elements in group 14 (e.g., carbon, silicon, tin, germanium, etc.), oxides, sulfides, transition metals, halides, and/or chalcogenides. In some examples, the first active material particles comprise silicon, silicon oxide, and/or a mixture thereof, and the first binder is configured to constrict expansion of the first active material particles during lithiation of the multilayered electrode.

In some examples, the multilayered electrode is a cathode suitable for inclusion within an electrochemical cell. In this case, the first active material particles may comprise transition metals (for example, nickel, cobalt, manganese, copper, zinc, vanadium, chromium, iron, etc.), and their oxides, phosphates, phosphites and silicates; alkalines and alkaline earth metals; aluminum, aluminum oxides and aluminum phosphates; halides; chalcogenides, and/or the like.

The coating process of step 404 (and step 406) may include any suitable coating method(s), such as slot die, blade coating, spray-based coating, electrostatic jet coating, and/or the like. In some examples, the first layer is coated as a wet slurry of solvent (e.g., water, NMP (N-Methyl-2-pyrrolidone), binder, conductive additive, and first particles. In some examples, the first layer is coated dry, as a plurality of first particles mixed with a binder and/or conductive additive. Step 404 may optionally include drying the first layer of the composite electrode.

Step 406 of method 400 includes coating a second layer onto the first layer, forming a multilayered (e.g., stratified) structure. The second layer may include a plurality of second particles adhered together by a second binder, the second particles having a second average particle size (or other second particle distribution). In some examples, the plurality of second particles comprise a plurality of second active material particles.

Second layer 220 comprises a second plurality of active material particles 222 mixed with second binder 224. In some examples, second layer 220 is layered onto and directly contacting first layer 210. Second binder 224 comprises materials which are not susceptible to coalescence, resulting in higher degrees of electrode springback in the second layer after calendering. Second binder 224 comprises any suitable binder materials which are not susceptible to coalescence, such as such as sodium carboxymethyl cellulose (NaCMC), poly(vinyl alcohol) (PVA), poly(acrylic acid) (PAA), sodium poly(acrylic acid) (NaPAA), sodium alginate, chitosan, guar gum, xanthan gum, polyethylene glycol, and/or the like.

In some examples, the second active material layer includes conductive additives intermixed with the second particles and the second binder. In some examples, the conductive additives comprise nanometer-sized carbons (e.g., carbon black), low dimensional carbons (e.g., carbon nanotubes), micron-sized carbons (e.g., flake graphite), ketjen black, graphitic carbon, carbon fiber, and/or the like.

In some examples, as described above, the multilayered electrode is an anode suitable for inclusion within an electrochemical cell. In this case, the second active material particles may comprise graphite (artificial or natural), hard carbon, lithium metal, silicon, silicon oxide, titanate, titania, transition metals in general, elements in group 14 group 14 (e.g., carbon, silicon, tin, germanium, etc.), oxides, sulfides, transition metals, halides, and/or chalcogenides. In some examples, the second active material particles comprise graphite.

In some examples, the multilayered electrode is a cathode suitable for inclusion within an electrochemical cell. In this case, the second active material particles may comprise transition metals (for example, nickel, cobalt, manganese, copper, zinc, vanadium, chromium, iron, etc.), and their oxides, phosphates, phosphites and silicates; alkalines and alkaline earth metals; aluminum, aluminum oxides and aluminum phosphates; halides; chalcogenides, and/or the like.

In some examples, steps 404 and 406 may be performed substantially simultaneously. For example, the first layer and the second layer may be extruded through their respective orifices simultaneously.

Simultaneous extrusion of slurries forms a multi-layered slurry bead and coating on the moving substrate. In some examples, differences in viscosities, differences in surface tensions, differences in densities, differences in solid contents, and/or different solvents used between the first slurry and the second slurry may be tailored to cause interpenetrating finger structures at the boundary between the two composite layers. Creation of interpenetrating structures, if desired, may be facilitated by turbulent flow at the wet interface between the first active material slurry and the second active material slurry, creating partial intermixing of the two slurries.

To facilitate proper curing in the drying process, the first layer (closest to the current collector) may be configured (in some examples) to be dried from solvent prior to the second layer (further from the current collector) so as to avoid creating skin-over effects and blusters in the resulting dried coatings.

In some examples, any of the described steps may be repeated to form three or more layers. For example, an additional layer or layers may include active materials to form a multilayered electrode with three active material layers. In some examples, an additional layer or layers may include inorganic ceramic separator particles configured to function as a separator for the multilayered electrode. Any method described herein to impart structure between adjacent layers may be utilized to form similar structures between any additional layers deposited during the manufacturing process.

Step 408 of method 400 includes drying the composite electrode. The first and second layers may experience the drying process as a combined structure. In some examples, drying step 408 includes a form of heating and energy transport to and from the electrode (e.g., convection, conduction, radiation) to expedite the drying process. In some examples, drying step 408 includes causing the coated current collector substrate to move relative to a plurality of heating elements. In some examples, drying step 408 includes moving the coated current collector substrate through an oven, furnace, or other enclosed heating environment. In some examples, drying step 408 may promote coalescence and/or crosslinking of the first binder.

Step 410 of method 400 includes calendering the composite electrode. The first and second layers may experience the calendering process as a combined structure. In some examples, calendering is replaced with another compression, pressing, or compaction process. In some examples, calendering the composite electrode further includes heating the composite electrode, such that binders included in the composite electrode coalesce and/or crosslink, forming a coherent structure surrounding the first active material particles. In some examples, calendering the electrode may be performed by pressing the combined first and second layers against the substrate, such that electrode density is increased in a non-uniform manner, with the first layer having a first porosity and the second layer having a second porosity. The second porosity may be lower than the first porosity while the composite electrode is calendered. However, after the composite electrode has been calendered, the second layer may spring back by a greater percentage of electrode thickness than the first layer, resulting in the second layer having a porosity greater and/or equal to the first porosity. In some examples, the second layer may spring back by 15-20% and the first electrode layer may spring back by 0-5% of an uncompressed electrode thickness. In some examples, step 408 and step 410 may be combined (e.g., in a hot roll calendering process). Step 408 and step 410 may individually and/or collectively facilitate the production of a desirable porosity profile in the multilayered electrode. Heating (e.g., drying) and/or calendering the multilayered electrode causes active material particles, binders, and electrode additives included in the first layer and second layer to deform, either reversibly or irreversibly. For example, the first binder may comprise a binder emulsion, and the emulsion may coalesce as solvents in the first electrode slurry evaporate. As the first binder is configured to coalesce and/or crosslink upon drying and/or calendering, the first active material layer significantly decreases in porosity and increases in density. Formation of crosslinks or coalescence of binder materials irreversibly changes the microstructure of the first electrode layer, resulting in comparatively low levels of electrode springback. In contrast, the second binder is not susceptible to coalescence upon drying and/or calendering, resulting in comparatively minor changes in porosity in density. For example, the second binder may comprise a binder solution, and drying and/or calendering may cause interwoven linear polymer chains to precipitate out of a binder solution. In other words, the second binder materials are configured to deform at lower rates than the first binder material, resulting in a resilient second layer which springs back at a greater rate than first layer. As a result, the first layer permanently changes in thickness as a result of calendering, while the second layer “springs back” to a greater percentage of its uncalendered thickness.

In some examples, a calendering temperature and/or heating temperature may be selected based on respective glass transition temperatures (T g) of the first and second binders. In some examples, the first binder may have a lower glass transition temperature than the second binder, and the calendering and/or heating temperature may be between the glass transition temperature of the first binder and the glass transition temperature of the second binder (e.g., higher than the first glass transition temperature and lower than the second glass transition temperature). In some examples, the calendering and/or heating temperature may be below the glass transition temperature of both the first binder and the second binder. In some examples, the calendering temperature may be the same as the glass transition temperature of the first binder.

FIG. 5 shows an electrode undergoing a calendering process, in which particles in a second layer 606 can be calendered with a first layer 604. This may prevent a “crust” formation on the electrode, specifically on the first layer. A roller 610 may apply pressure to a fully assembled electrode 600. Electrode 600 may include first layer 604 and second layer 606 applied to a substrate web 602. First layer 604 may have a first uncompressed thickness 612 and second layer 606 may have a second uncompressed thickness 614 prior to calendering. After the electrode has been calendered, first layer 604 may have a first compressed thickness 616 and second layer 606 may have a second compressed thickness 618. In some examples, second layer 606 may have a higher degree of springback than first layer 604. After the electrode has been calendered, the second layer may return to a post-calendering thickness which represents a greater percentage of second uncompressed thickness 614 than the post-calendering thickness of the first layer represents to first uncompressed thickness 612.

Changes in porosity, density, and layer thickness experienced by the first active material layer and the second active material layer result in a desirable porosity profile after method steps 408 and 410. As the first active material layer springs back at a lower rate, the first active material layer has a higher density, a lower porosity, and a higher energy density. In contrast, the second active material layer has a lower density, a lower porosity, and a lower energy density.

In some examples, calendering the electrode may cause the first and the second layers to have tailored physical properties. In some examples, calendering the electrode may cause the first binder to be resistant to solvents (AKA not dissolvable). In contrast, the second binder may be selected to be dissolvable. Accordingly, the second binder may be dissolvable, and the first binder may not be dissolvable. In some examples, calendering the electrode may cause the first binder to have a glass transition temperature (T g) that is higher than the glass transition temperature of the second binder, as crosslinked binders have a higher glass transition temperature than linear binders due to an increase in molecular weight. In some examples, prior to calendering, the first binder has a glass transition temperature that is lower than the second binder. Accordingly, calendering the electrode causes the T g of the first binder to increase such that it is greater than the T g of the second binder. In some examples, calendering the electrode may cause first binder 314 to be resistant to melting.

### D. Illustrative Manufacturing Systems

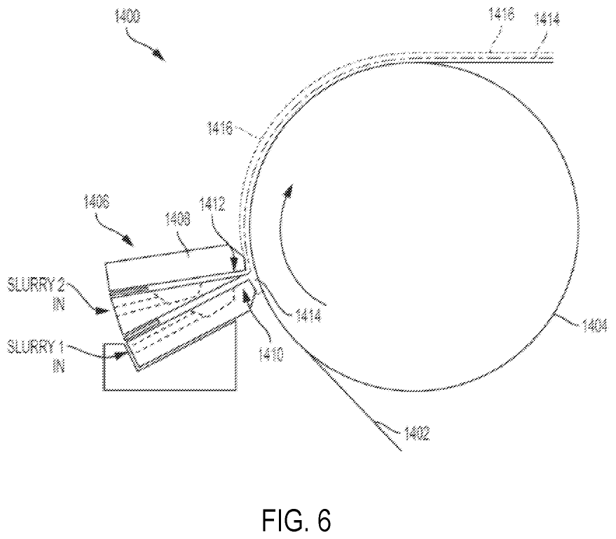

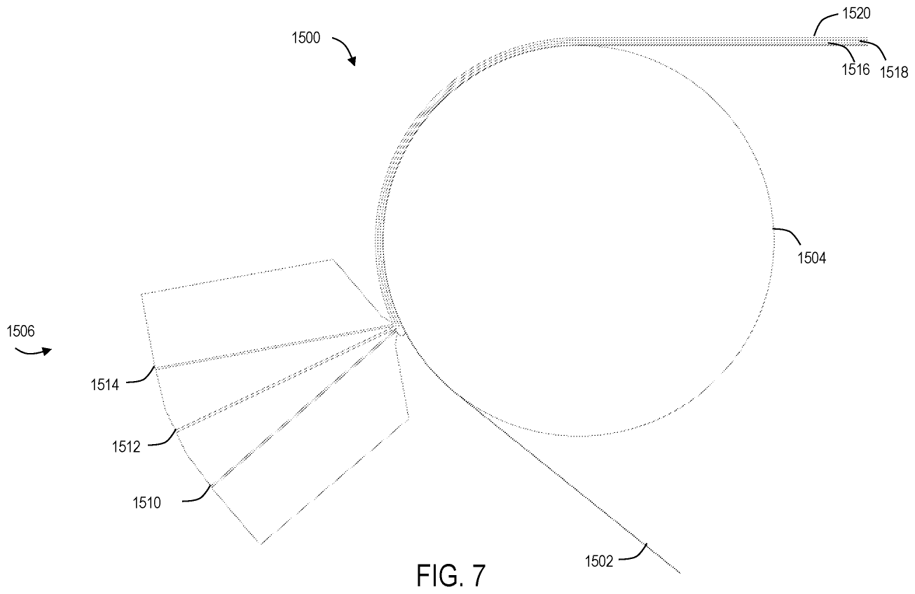

Turning to FIGS. 6 and 7, illustrative manufacturing systems 1400 and 1500 for use with method 400 will now be described. Illustrative manufacturing system 1400, as depicted in FIG. 6, includes a slot-die coating head with at least two fluid slots, fluid cavities, fluid lines, and fluid pumps, which may be utilized to manufacture a battery electrode including multiple layers (e.g., a multilayered electrode including tailored binder materials). In some examples, additional cavities may be utilized to create additional layers.

In system 1400, a foil substrate 1402 is transported by a revolving backing roll 1404 past a stationary dispenser device 1406. Dispenser device may include any suitable dispenser configured to evenly coat one or more layers of slurry onto the substrate. In some examples, the substrate may be held stationary while the dispenser head moves. In some examples, both the substrate and the dispenser head may be in motion. Dispenser device 1406 may, for example, include a dual chamber slot die coating device having a coating head 1408 with two orifices 1410 and 1412. A slurry delivery system may supply two different slurries to the coating head under pressure. Due to the revolving nature of backing roll 1404, material exiting the lower orifice or slot 1410 will contact substrate 1402 before material exiting the upper orifice or slot 1412. Accordingly, a first layer 1414 will be applied to the substrate and a second layer 1416 will be applied on top of the first layer.

Manufacturing method 400 may be performed using a dual-slot configuration, as depicted in FIG. 6, to simultaneously extrude the first layer (AKA top layer) and the second layer (AKA bottom layer), or a multi-slot configuration with three or more dispensing orifices utilized to simultaneously the first layer, the second layer, and an additional electrode layer such as an integrated porous separator layer, a carbon conductive layer, a third active material layer, and/or the like.

In some examples, manufacturing method 400 may be performed using manufacturing system 1500, which includes a tri-slot configuration, such that the first layer, the second layer, and a third electrode layer (e.g., an integrated porous separator layer, a carbon conductive layer, a third active material layer, etc.) may all be extruded simultaneously, as depicted in FIG. 8. In manufacturing system 1500, a foil substrate 1502 is transported by a revolving backing roll 1504 past a stationary dispenser device 1506. Dispenser device 1506 may include any suitable dispenser configured to evenly coat one or more layers of slurry onto the substrate. In some examples, the substrate may be held stationary while the dispenser head moves. In some examples, both the substrate and the dispenser head may be in motion. Dispenser device 1506 may, for example, include a three-chamber slot die coating device having a coating head 1508 with three orifices 1510, 1512, and 1514. A slurry delivery system may supply three different slurries to the coating head under pressure. Due to the revolving nature of backing roll 1504, material exiting the lower orifice or slot 1510 will contact substrate 1502 before material exiting the central orifice or slot 1512. Similarly, material exiting central orifice or slot 1512 will contact material exiting lower orifice or slot 1510 before material exiting upper orifice or slot 1514. Accordingly, a first layer 1516 will be applied to the substrate, a second layer 1518 will be applied on top of the first layer, and a third layer 1520 will be applied on top of the second layer.

### E. Illustrative Combinations and Additional Examples

This section describes additional aspects and features of binder materials for multilayered electrodes, presented without limitation as a series of paragraphs, some or all of which may be alphanumerically designated for clarity and efficiency. Each of these paragraphs can be combined with one or more other paragraphs, and/or with disclosure from elsewhere in this application, in any suitable manner. Some of the paragraphs below expressly refer to and further limit other paragraphs, providing without limitation examples of some of the suitable combinations.

A0. A multilayered electrode comprising:
a current collector;
a first layer comprising a first plurality of active material particles adhered together by a first binder; and
a second layer comprising a second plurality of active material particles adhered together by a second binder;
wherein the first binder comprises binder materials configured to coalesce upon calendering; and
wherein the second binder comprises binder materials not susceptible to coalescing upon calendering.

A1. The multilayered electrode of paragraph A0, wherein the first binder has a first glass transition temperature, the second binder has a second glass transition temperature, and wherein the first glass transition temperature is less than the second glass transition temperature.

A2. The multilayered electrode of paragraph A0 or A1, wherein the first binder comprises a latex.

A3. The multilayered electrode of any of paragraphs A0 through A2, wherein the first binder comprises an emulsion.

A4. The multilayered electrode of any of paragraphs A0 through A3, wherein the second binder comprises a crystalline polymer.

A5. The multilayered electrode of any of paragraphs A0 through A4, wherein the electrode is an anode.

A6. The multilayered electrode of paragraph A5, wherein the first plurality of active material particles comprises silicon oxide, and wherein the first binder is configured to suppress expansion of the silicon oxide particles.

A7. The multilayered electrode of paragraph A5, wherein the first plurality of active material particles comprises silicon, and wherein the first binder is configured to suppress expansion of the silicon particles.

A8. The multilayered electrode of paragraph A6 or A7, wherein the second plurality of active material particles comprises graphite.

A9. The method of any of paragraphs A0 through A4, wherein the electrode is a cathode.

A10. The method of paragraph A9, wherein the first binder comprises a dispersion of water soluble wax particles.

A11. The method of paragraph A10, wherein the water soluble wax particles comprise polyethylene glycol.

A12. The multilayered electrode of any of paragraphs A0 through A11, wherein the second layer is configured to spring back by a greater percentage of an initial thickness of the second layer than the first layer.

A13. The multilayered electrode of any of paragraphs A0 through A12, wherein the second layer is more porous than the first layer.

A14. The multilayered electrode of any of paragraphs A0 through A13, wherein the first binder comprises styrene butadiene rubber.

A15. The multilayered electrode of any of paragraphs A0 through A14, wherein the second binder comprises sodium-carboxymethyl cellulose.

A16. The multilayered electrode of any of paragraphs A0 through A15, wherein the second layer is more resilient than the first layer.

A17. The multilayered electrode of any of paragraphs A0 through A16, wherein the second binder is dissolvable.

B0. A multilayered electrode comprising:
a current collector;
a first layer comprising a first plurality of active material particles adhered together by a first binder; and
a second layer comprising a second plurality of active material particles adhered together by a second binder;
wherein the first binder comprises binder materials configured to crosslink upon calendering; and
wherein the second binder comprises binder materials not susceptible to crosslinking upon calendering.

B1. The multilayered electrode of paragraph B0, wherein the first binder comprises a first polymer mixed with a crosslinking agent, and wherein the second binder consists essentially of the first polymer.

B2. The multilayered electrode of paragraph B0, wherein the first binder comprises a first polymer comprises a first polymer mixed with a crosslinking agent, and wherein the second binder comprises a sodium salt of the first polymer.

B3. The multilayered electrode of any of paragraphs B0 through B2, wherein the electrode is an anode.

B4. The multilayered electrode of paragraph B3, wherein the first plurality of active material particles comprises silicon oxide, and wherein the first binder is configured to suppress expansion of the silicon oxide particles.

B5. The multilayered electrode of paragraph B3, wherein the first plurality of active material particles comprises silicon, and wherein the first binder is configured to suppress expansion of the silicon particles.

B6. The multilayered electrode of paragraph B4 or B5, wherein the second plurality of active material particles comprises graphite.

B7. The multilayered electrode of any of paragraphs B0 through B6, wherein the second layer is configured to spring back by a greater percentage of an initial thickness of the second layer than the first layer.

B8. The multilayered electrode of any of paragraphs B0 through B7, wherein the second layer is more porous than the first layer.

B9. The multilayered electrode of any of paragraphs B0 through B8, wherein the first binder comprises carboxymethyl cellulose/polyacrylic acid.

B10. The multilayered electrode of any of paragraphs B0, B1, or B3 through B9, wherein the second binder comprises polyacrylic acid.

B11. The multilayered electrode of any of paragraphs B0 through B10, wherein the second layer is more resilient than the first layer.

B12. The multilayered electrode of any of paragraphs B0 through B11, wherein the second binder is dissolvable.

C0. A multilayered electrode comprising:
a current collector;
a first layer comprising a first plurality of active material particles adhered together by a first binder; and
a second layer comprising a second plurality of active material particles adhered together by a second binder;
wherein the first binder comprises a latex film immobilizing the first plurality of active material particles.

C1. The multilayered electrode of paragraph C0, wherein the second binder comprises a crystalline polymer.

C2. The multilayered electrode of paragraph C0, wherein the first binder has a first glass transition temperature, the second binder has a second glass transition temperature, and wherein the first glass transition temperature is greater than the second glass transition temperature.

C3. The multilayered electrode of any of paragraphs C0 through C2, wherein the electrode is an anode.

C4. The multilayered electrode of paragraph C3, wherein the first plurality of active material particles comprises silicon oxide, and wherein the first binder is configured to suppress expansion of the silicon oxide particles.

C5. The multilayered electrode of paragraph C3, wherein the first plurality of active material particles comprises silicon, and wherein the first binder is configured to suppress expansion of the silicon particles.

C6. The multilayered electrode of paragraph C4 or C5, wherein the second plurality of active material particles comprises graphite.

C7. The method of any of paragraphs C0 through C2, wherein the electrode is a cathode.

C8. The method of paragraph C7, wherein the first binder comprises a dispersion of water soluble wax particles.

C9. The method of paragraph C8, wherein the water soluble wax particles comprise polyethylene glycol.

C10. The multilayered electrode of any of paragraphs C0 through C9, wherein the second layer is configured to spring back by a greater percentage of an initial thickness of the second layer than the first layer.

C11. The multilayered electrode of any of paragraphs C0 through C10, wherein the second layer is more porous than the first layer.

C12. The multilayered electrode of any of paragraphs C0 through C11, wherein the first binder comprises styrene butadiene rubber.

C13. The multilayered electrode of any of paragraphs C0 through C12, wherein the second binder comprises sodium-carboxymethyl cellulose.

C14. The multilayered electrode of any of paragraphs C0 through C13, wherein the second layer is more resilient than the first layer.

C15. The multilayered electrode of any of paragraphs C0 through C14, wherein the second binder is dissolvable.

D0. A multilayered electrode comprising:
a current collector;
a first layer comprising a first plurality of electrode particles adhered together by a first binder; and
a second layer comprising a second plurality of electrode particles adhered together by a second binder;
wherein the first binder is more crosslinked than the second binder.

D1. The multilayered electrode of paragraph D0, wherein the first binder comprises a first polymer mixed with a crosslinking agent, and wherein the second binder consists essentially of the first polymer.

D2. The multilayered electrode of paragraph D0, wherein the first binder comprises a first polymer comprises a first polymer mixed with a crosslinking agent, and wherein the second binder comprises a sodium salt of the first polymer.

D3. The multilayered electrode of any of paragraphs D0 through D2, wherein the electrode is an anode.

D4. The multilayered electrode of paragraph D3, wherein the first plurality of active material particles comprises silicon oxide, and wherein the first binder is configured to suppress expansion of the silicon oxide particles.

D5. The multilayered electrode of paragraph D3, wherein the first plurality of active material particles comprises silicon, and wherein the first binder is configured to suppress expansion of the silicon particles.

D6. The multilayered electrode of paragraph D4 or D5, wherein the second plurality of active material particles comprises graphite.

D7. The multilayered electrode of any of paragraphs D0 through D6, wherein the second layer is configured to spring back by a greater percentage of an initial thickness of the second layer than the first layer.

D8. The multilayered electrode of any of paragraphs D0 through D7, wherein the second layer is more porous than the first layer.

D9. The multilayered electrode of any of paragraphs D0 through D8, wherein the first binder comprises carboxymethyl cellulose/polyacrylic acid.

D10. The multilayered electrode of any of paragraphs D0, D1, or D3 through D9, wherein the second binder comprises polyacrylic acid.

D11. The multilayered electrode of any of paragraphs D0 through D10, wherein the second layer is more resilient than the first layer.

D12. The multilayered electrode of any of paragraphs D0 through D11, wherein the second binder is dissolvable.

E0. A method of manufacturing a multilayered electrode, the method comprising:
coating a first layer onto a current collector, the first layer comprising a first plurality of active material particles adhered together by a first binder, wherein the first binder comprises binder materials configured to coalesce upon calendering;
coating a second layer onto the first layer, the second layer comprising a second plurality of active material particles adhered together by a second binder, wherein the second binder comprises binder materials not susceptible to coalescence upon calendering; and
causing the first binder to coalesce and form a film surrounding the first plurality of active material particles by calendering the electrode.

E1. The method of paragraph E0, further comprising drying the electrode.

E2. The method of paragraph E0 or E1, wherein calendering the electrode comprises compressing the electrode between a pair of heated rollers.

E3. The method of any of paragraphs E0 through E2, wherein the second binder comprises a crystalline polymer.

E4. The method of any of paragraphs E0 through E3, wherein the first binder has a first glass transition temperature, the second binder has a second glass transition temperature, and wherein the first glass transition temperature is less than the second glass transition temperature.

E5. The method of paragraph E4, wherein a calendering temperature of the calendering rollers is greater than the first glass transition temperature and less than the second glass transition temperature.

E6. The method of any of paragraphs E0 through E5, wherein the electrode is an anode.

E7. The method of paragraph E6, wherein the first plurality of active material particles comprises silicon oxide, and wherein the first binder is configured to suppress expansion of the silicon oxide particles.

E8. The method of paragraph E6, wherein the first plurality of active material particles comprises silicon, and wherein the first binder is configured to suppress expansion of the silicon particles.

E9. The method of paragraph E7 or E8, wherein the second plurality of active material particles comprises graphite.

E10. The method of any of paragraphs E0 through E5, wherein the electrode is a cathode.

E12. The method of paragraph E10, wherein the first binder comprises a dispersion of water soluble wax particles.

E13. The method of paragraph E12, wherein the water soluble wax particles comprise polyethylene glycol.

E14. The method of any of paragraphs E0 through E13, wherein the second layer is configured to spring back by a greater percentage of an initial thickness of the second layer than the first layer.

E15. The method of any of paragraphs E0 through E14, wherein, after calendering the electrode, the first layer is porous than the second layer.

E16. The method of any of paragraphs E0 through E15, wherein the first binder comprises styrene butadiene rubber.

E17. The method of any of paragraphs E0 through E16, wherein the second binder comprises sodium-carboxymethyl cellulose.

F0. A method of manufacturing a multilayered electrode, the method comprising:
coating a first layer onto a current collector, the first layer comprising a first plurality of active material particles adhered together by a first binder, wherein the first binder comprises binder materials configured to crosslink upon calendering;
coating a second layer onto the first layer, the second layer comprising a second plurality of active material particles adhered together by a second binder, wherein the second binder comprises binder materials not susceptible to crosslinking upon calendering; and
causing the first binder to crosslink and form a networked matrix surrounding the first plurality of active material particles by calendering the electrode.

F1. The method of paragraph F0, further comprising drying the electrode.

F2. The method of paragraph F0 or F1, wherein calendering the electrode comprises compressing the electrode between a pair of heated rollers.

F3. The method of any of paragraphs F0 through F2, wherein the first binder comprises a first polymer mixed with a crosslinking agent, and wherein the second binder consists essentially of the first polymer.

F4. The method of any of paragraphs F0 through F2, wherein the first binder comprises a first polymer comprises a first polymer mixed with a crosslinking agent, and wherein the second binder comprises a sodium salt of the first polymer.

F5. The method of any of paragraphs F0 through F4, wherein the electrode is an anode.

F6. The method of paragraph F5, wherein the first plurality of active material particles comprises silicon oxide, and wherein the first binder is configured to suppress expansion of the silicon oxide particles.

F7. The method of paragraph F5, wherein the first plurality of active material particles comprises silicon, and wherein the first binder is configured to suppress expansion of the silicon particles.

F8. The method of paragraph F6 or F7, wherein the second plurality of active material particles comprises graphite.

F9. The method of any of paragraphs F0 through F8, wherein the second layer is configured to spring back by a greater percentage of an initial thickness of the second layer than the first layer.

F10. The method of any of paragraphs F0 through F9, wherein the second layer is more porous than the first layer.

F11. The method of any of paragraphs F0 through F10, wherein the first binder comprises carboxymethyl cellulose/polyacrylic acid.

F12. The method of any of paragraphs F0 through F3 and F5 through F11, wherein the second binder comprises polyacrylic acid.

### Advantages, Features, and Benefits

The different embodiments and examples of the multilayered electrode described herein provide several advantages over known electrodes. For example, illustrative embodiments and examples described herein preferentially spring back to create a desired porosity profile, leveraging different binder systems in a first and second layer.

Additionally, and among other benefits, illustrative embodiments and examples described herein constrict silicon expansion in silicon-graphite composite anodes including silicon concentrated in the bottom layer.

Additionally, and among other benefits, illustrative embodiments and examples described herein constrict electrode springback post calendering.

No known system or device can perform these functions. However, not all embodiments and examples described herein provide the same advantages or the same degree of advantage.

### CONCLUSION

The disclosure set forth above may encompass multiple distinct examples with independent utility. Although each of these has been disclosed in its preferred form(s), the specific embodiments thereof as disclosed and illustrated herein are not to be considered in a limiting sense, because numerous variations are possible. To the extent that section headings are used within this disclosure, such headings are for organizational purposes only. The subject matter of the disclosure includes all novel and nonobvious combinations and subcombinations of the various elements, features, functions, and/or properties disclosed herein. The following claims particularly point out certain combinations and subcombinations regarded as novel and nonobvious. Other combinations and subcombinations of features, functions, elements, and/or properties may be claimed in applications claiming priority from this or a related application. Such claims, whether broader, narrower, equal, or different in scope to the original claims, also are regarded as included within the subject matter of the present disclosure.

1. A multilayered electrode comprising:
a current collector;
a first layer directly contacting the current collector, the first layer comprising a first plurality of active material particles adhered together by a first binder; and
a second layer directly contacting the first layer, the second layer comprising a second plurality of active material particles adhered together by a second binder;
wherein the first binder is more crosslinked than the second binder;
wherein the first plurality of active material particles comprises silicon oxide; and
wherein the second binder is dissolvable in water, and wherein the first binder is not dissolvable in water.

2. The multilayered electrode of claim 1, wherein the first binder comprises a first polymer mixed with a crosslinking agent, and wherein the second binder consists essentially of the first polymer.

3. The multilayered electrode of claim 1, wherein the first binder comprises a first polymer mixed with a crosslinking agent, and wherein the second binder comprises a sodium salt of the first polymer.

4. The multilayered electrode of claim 1, wherein the electrode is an anode.

5. (canceled)

6. The multilayered electrode of claim 1, wherein the second plurality of active material particles comprises graphite.

7-13. (canceled)

14. A method of manufacturing a multilayered electrode, the method comprising:
coating a first layer onto a current collector, the first layer comprising a first plurality of active material particles adhered together by a first binder, wherein the first binder comprises binder materials configured to coalesce upon calendering;
coating a second layer onto the first layer, the second layer comprising a second plurality of active material particles adhered together by a second binder, wherein the second binder comprises binder materials not susceptible to coalescence upon calendering; and
causing the first binder to coalesce and form a film surrounding the first plurality of active material particles by calendering the electrode.

15. The method of claim 14, further comprising drying the electrode.

16. The method of claim 14, wherein calendering the electrode includes compressing the electrode between a pair of heated rollers.

17. The method of claim 14, wherein the first binder has a first glass transition temperature, the second binder has a second glass transition temperature, and wherein the first glass transition temperature is less than the second glass transition temperature.

18. The method of claim 17, wherein a temperature at which the electrode is calendered is higher than the first glass transition temperature and lower than the second glass transition temperature.

19. The method of claim 14, wherein the second layer is configured to spring back after calendering by a greater percentage of an initial thickness of the second layer than the first layer.

20. The method of claim 14, wherein, after calendering the electrode, the first layer is less porous than the second layer.

21. A multilayered electrode comprising:
a current collector;
a first layer directly contacting the current collector, the first layer comprising a first plurality of active material particles adhered together by a first binder; and
a second layer directly contacting the first layer, the second layer comprising a second plurality of active material particles adhered together by a second binder;
wherein the first binder is more crosslinked than the second binder;
wherein the first plurality of active material particles comprises silicon oxide; and
wherein the second binder is dissolvable in water, and wherein the first binder is not dissolvable in water.

22. The multilayered electrode of claim 21, wherein the first binder comprises a first polymer mixed with a crosslinking agent, and wherein the second binder consists essentially of the first polymer.

23. The multilayered electrode of claim 21, wherein the first binder comprises a first polymer mixed with a crosslinking agent, and wherein the second binder comprises a sodium salt of the first polymer.

24. The multilayered electrode of claim 21, wherein the electrode is an anode.

25. The multilayered electrode of claim 21, wherein the second plurality of active material particles comprises graphite.
